(19) United States
(12) Patent Application Publication
(10) Pub. No.: US 2012/0046901 A1
(43) Pub. Date: Feb. 23, 2012

(54) MOTION CAPTURE APPARATUS

(75) Inventors: Jonathan Anthony Green, Cambridgeshire (GB); Gregory Charles Sporton, West Midlands (GB)

(73) Assignee: BIRMINGHAM CITY UNIVERSITY, BIRMINGHAM, WEST MIDLANDS (GB)

(21) Appl. No.: 13/145,754

(22) PCT Filed: Jan. 21, 2010
(86) PCT No.: PCT/GB2010/050082

§ 371 Date: Nov. 9, 2011

(30) Foreign Application Priority Data
Jan. 21, 2009 (GB) 0901020.8

(51) Int. Cl. G06F 15/00

(52) U.S. Cl. 702/141

(57) ABSTRACT

A motion capture apparatus (10) comprises a series of sensor nodes (12) connected to a transceiver hub. Each node (12) comprises a 3D accelerometer (20), a (3) axis gyroscope array 21a, b and a microprocessor (29) on one side of a double-sided PCB (18). A vibration transducer (31) is arranged on the other side of the PCB (18). A controller receives sensed data from multiple nodes enabling the relative angle between nodes to be determined periodically. The controller multiplexes between receiving sensed data from the node and activating/deactivating the transducer (31) to give the impression of simultaneous sensing and vibration without the vibration affecting the sensed data.

The invention relates to a motion capture apparatus, particularly for capturing the motion of a human or animal and creating a model of that motion.

Motion capture is most closely associated with the entertainment and games industries and describes the process of recording movement, normally human or animal movement, and translating that into a digital model. The model can then be used, for example, to generate an animated character in a film or game.

Various methods of motion capture are known and they can be split into two main types, optical systems and non-optical systems. Optical systems use markers whether reflective or light-emitting to generate a series of points which are filmed with high quality cameras. Multiple cameras are used to provide a 3-dimensional assessment. The multiple marker points are then mapped onto a computer model. Optical systems even include marker-less arrangements where the computer can analyse multiple streams of optical input and identify motion and body forms.

Non-optical systems include inertial systems which use gyroscopes to measure rotations. Likewise, mechanical systems are known using potentiometers and a rigid exoskeleton which mimics the articulation of the joints of the body. Typical inertial system suits or mechanical system suits cost tens of thousands of US Dollars and weigh many kilograms. The suits can be extremely cumbersome and can have the effect of constraining natural motion which can produce an artificial-looking result when the motion is modelled.

Most of the developments in motion capture systems have been to improve the accuracy of motion capture and body modelling. However, the inventors of the present device have made the inventive realisation that for many applications, absolutely faithful modelling of movement is unnecessary. High levels of accuracy are not required in many situations and instead a slightly lower level of accuracy can be accepted in return for lower cost, lower weight, motion capture apparatus.

It is an object of the invention to provide an improved motion capture apparatus.

According to a first aspect of the invention there is provided a motion capture apparatus comprising a first 3-dimensional accelerometer, which can output a signal relative to its angular orientation, a second 3-dimensional accelerometer which can output a signal relative to its angular orientation, a processor for processing the angular orientation signals of the accelerometers and for determining the relative angle between the first and second accelerometers.

Each three dimensional accelerometer may comprise two two-dimensional accelerometers configured to measure accelerations in three dimensions. Any configuration of one, two or three dimensional accelerometers may be combined as lon gas they are configured as a whole to measure accelerations in three dimensions.

In that way, a simple motion capture apparatus can be provided which merely determines the angular orientation between body parts, for example between the forearm and the upper arm or between the thighs and the back of a person. This arrangement is advantageous in various applications, for example in the performing arts where it may be preferable to provide a lighter motion capture apparatus for example when attempting to capture dance motions, to model them and to replicate them. Also, it is envisaged that the apparatus could be useful in training certain physical actions, for example in health and safety training for lifting objects. The system can provide a certification method for firstly training, then certifying that a person has been taught the correct way to lift an object and to demonstrate that the person understands that and can repeat the correct motion. As the accelerometers can measure dynamic acceleration as well as static acceleration (e.g. gravity), movements can be detected and modelled, as well as angular orientations.

More than two 3-dimensional accelerometers may be provided and, in that case, it is preferable that the processor determines the relative angles between all of the accelerometers. The processor may be connected to the accelerometers on a modular basis so that more or less accelerometers can be connected to the processor depending upon the motion to be captured. The processor may map the angular orientation of the accelerometers onto a stored model to generate a simulation of the movement. Where the motion being captured is the movement of a human or animal body, the stored model may be a generic model or the model may simulate a particular body, for example, by having specific body measurements taken and stored, i.e. forearm length, thigh length etc.

Each accelerometer may form part of a sensor node. The sensor node preferably comprises the accelerometer, a data output port, an analog input for an alternative form of sensor and, optionally, a data input port. By providing data input and output in each node, the nodes may be connected serially. The alternative sensor may comprise a flexion sensor which can be applied around a joint of a user to determine the extent of bending. Alternatively, the sensor could be a pressure sensor. In that case, the sensor node could be used in a shoe and if both shoes have the sensors then weight distribution can be determined using the pressure sensors. Most preferably, each node comprises a three-axis accelerometer, and a three axis gyroscope array such as a dual axis gyroscope and a single axis gyroscope. Each sensor node preferably comprises a double-sided printed circuit board. Each sensor node may further include a vibration transducer which can be activated by the processor. The vibration transducer can be used to provide a sensory input at a certain physical position or orientations of sensors, so-called “haptic feedback” For example, in health and safety application, the apparatus can be used to “train” a user to adopt the correct posture when lifting. The vibration transducer can vibrate when the user has adopted an incorrect posture. If each node is equipped with a vibration transducer, the body part or parts that are in the incorrect position can be indicated by means of the vibration transducer. Another application of the vibration transducer is the concept of a virtual instrument. For example, a virtual harp may be provided in which virtual strings are laid out in front of a user. As the arm moves horizontally across the space the vibration produced by the transducer can be intensified as the arm gets closer to a virtual string. The accelerometer and, where present, the gyroscopes, may be arranged on one side of the printed circuit board and the vibration transducer on the other. Each such node may be encapsulated in a tight fitting enclosure, such as a plastic or rubber enclosure to ensure vibration effected by the transducer is transmitted to the user wearing the sensor node. Each node can vibrate independently and at varying intensities. Haptic feedback is most useful because in motion training, a reliance on visual feedback can be detrimental to the physical movement exercise as the user might have to move his/her head to see a computer screen. Haptic feedback gives the user instant feedback on any part of the body that a node is situated. Thus, if the lower left leg is too high, feedback will be sent to the node that is located on the lower left leg.

Each sensor node has a unique ID and thus, when connected to a hub, can form a local area network. The hub to which the sensor nodes are connected preferably communicates sensed data to a processor wirelessly although a wired connection may be used. Likewise, the hub is preferably battery powered, preferably by rechargeable internal high capacity batteries, although again a mains power supply is possible. Each sensor node may act as a master for a series of other nodes serially connected to it. The master node is connected directly to the hub. The hub is preferably a transceiver module with multiple input ports for receiving a data cable from a master sensor node. The network is preferably a RS485 network and in such a case the nodes and hub comply with the RS485 communication protocol. The transceiver module or hub preferably includes a USB port or a micro-USB port. All sensor nodes are powered centrally from the transceiver using the same cable that carries the data. The transceiver module or hub may include a DC socket to allow powering from mains or charging of the internal batteries.

Each sensor node preferably comprises an analogue to digital converter to convert an analogue signal from the accelerometer to a digital signal. Digitising signals locally ensures there is no signal loss at all between sensor nodes and the transceiver, and allows the possibility of different sensor configurations. The present system can therefore be used in electronically challenging environments without compromise, whereas an analogue system would exhibit a large amount of interference on the analogue data. Digitising sensor values on the sensor nodes also allows the nodes to be attached to themselves and the transceiver as an RS485 network. The sensors are preferably factory calibrated to output at 8 bits or even more preferably 10 bits. A user calibration calibrates the 8 bit output to 7 bits or the 10 bit output to 8 bits and an algorithm maps the calibrated range of movement across all available 128 bit values. This ensures the maximum and constant data resolution for the predicted range of movements. The hub acts as a modem between six RS485 master nodes and one or more WiFi connections. The data passed between the transceiver and the computer is preferably in the form of standard TCP/IP packets to prevent against corrupt data. Additionally, the transceiver may verify all data received from sensor nodes using a checksum to remove corrupt data. Each sensor node may include a microprocessor to receive signal data from the accelerometer and, optionally, the gyroscopes and/or to control the vibration transducer. Alternatively, each sensor node can receive a control signal from the transceiver node or hub, so that the vibration transducer is controlled directly by the controller.

The transceiver receives data signals from the sensor nodes and transmits that data to a controller, such as a PC. The transceiver also transmits data related to battery voltage to the controller. The transceiver may stream all data from the nodes and transmit it to the controller. Alternatively, the transceiver may transmit data in response to a call for data from the controller.

Multiple hubs may be provided, each having a user-configurable IP address. This allows multiple hubs to be controlled by a single controller. It also allows hubs to be controlled via the internet.

Where the sensor node has a vibration transducer, the apparatus preferably includes a multiplexer to effect alternative actuation of the transducer and data collection from the accelerometer. Haptic feedback can interfere with the accelerometer. The present apparatus solves this problem by multiplexing between the sensors and the motor. The motor is rarely on all the time. Instead, it is pulsed on and off very quickly to provide varying amounts of feedback. When the motor is off, a sensor reading is taken. Therefore, the sensor readings and haptic feedback seem to be happening at the same time due to the high speed of the multiplexing, but in fact they are not.

The controller may include a low pass filter in software or hardware to filter out shaking body movements or residual vibrations following transducer deactivation to enable slower movements to be monitored. Alternatively the low pass filter may be on the node or the hub.

Most preferably, the microprocessor on the node carries out the functions of one or more of analogue to digital conversion of signals from the accelerometer and/or gyroscopes, activation and deactivation of vibration transducer, low pass filtering of sensed data, transmission of data on call from controller.

The data output can be associated with audio and/or visual signals, for example electronically synthesised sound or a lighting display. Alternatively, the output data could be used to control a robot. According to a second aspect of the invention, there is provided a sensor node for use in a motion capture apparatus comprising a double sided printed circuit board, a three dimensional accelerometer, on one side of the printed circuit board and a vibration transducer on the other side of the printed circuit board.

This ensures that haptic feedback occurs at substantially the same point on the user's body as the sensed motion giving rise to the feedback. Preferably, the node has any of the preferred features described above with reference to the first aspect of the invention. Preferably, the printed circuit board is mounted in a body in such a way that the vibration caused by the vibration transducer is substantially immediately attenuated when the transducer is deactivated.

According to a third aspect of the invention, there is provided a motion capture and haptic feedback device comprising a sensor unit having a three dimensional accelerometer and a vibration transducer therein, a processor for receiving a signal from the accelerometer and a multiplexer for alternating between a first state in which a signal can be received in the processor from the accelerometer and the transducer is deactivated and a second state in which a control signal can be sent to the vibration transducer but a signal cannot be received in the processor from the accelerometer or a signal received from the accelerometer is disregarded by the processor.

That arrangement reduces the effect of the vibration caused by the transducer on the measurement of movement by the accelerometer. The sensor unit preferably comprises a sensor node according to the second aspect of the invention.

A motion capture apparatus in accordance with the invention will now be described in detail by way of example and with reference to the accompanying drawings, in which:

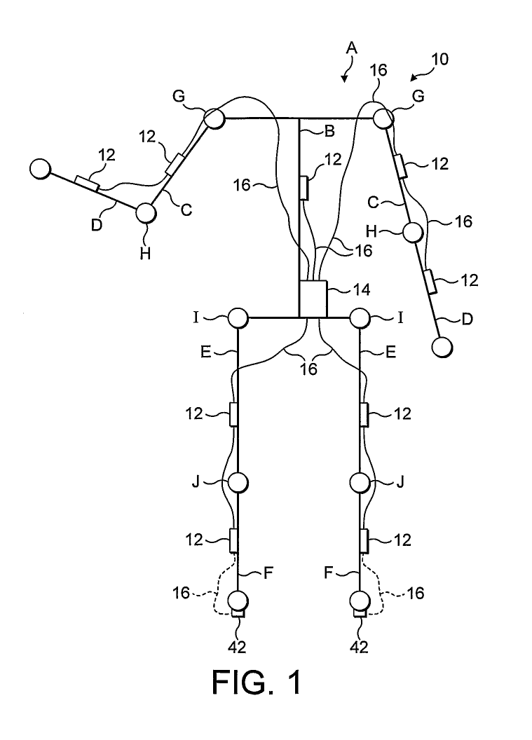

FIG. 1 is a schematic elevation of a motion capture apparatus in accordance with the invention on a body,

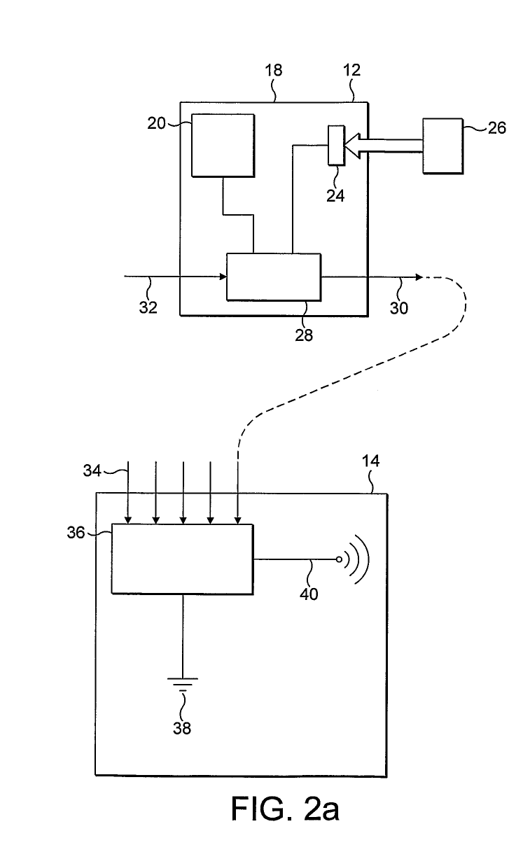

FIG. 2a is a schematic representation of the accelerometer arrangement on a sensor node,

FIG. 2b is a view similar to FIG. 2a for an alternative sensor node,

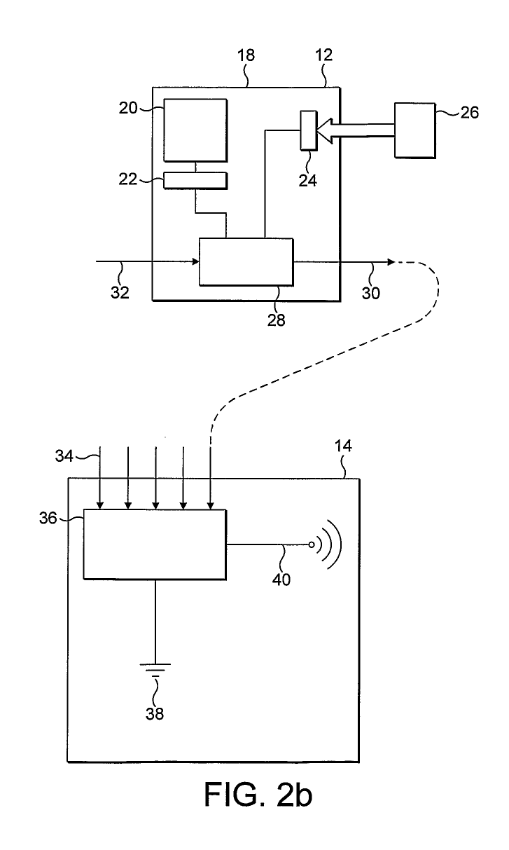

FIG. 3 illustrates the operation of the motion capture apparatus of FIG. 2b,

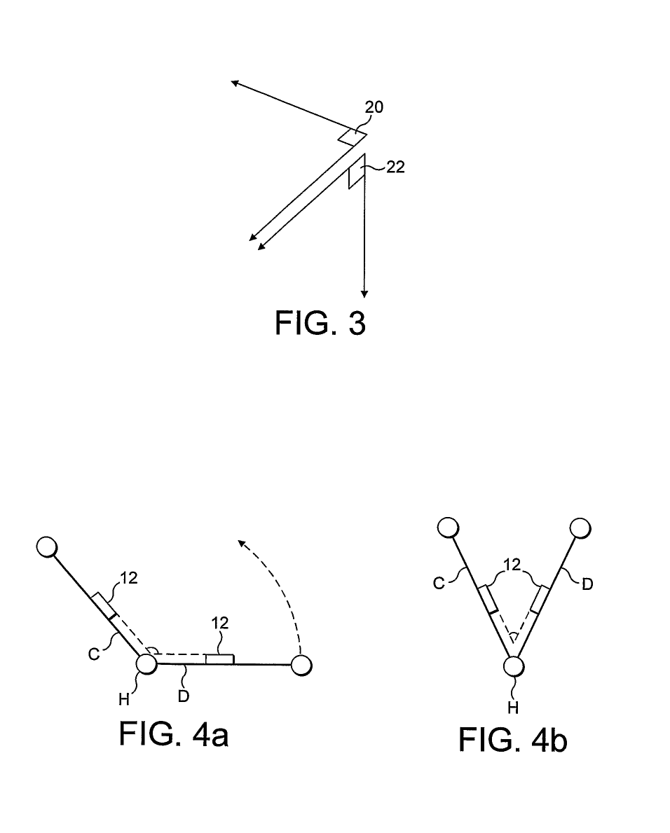

FIGS. 4a and 4b illustrate the use of the motion capture apparatus on a limb of a user,

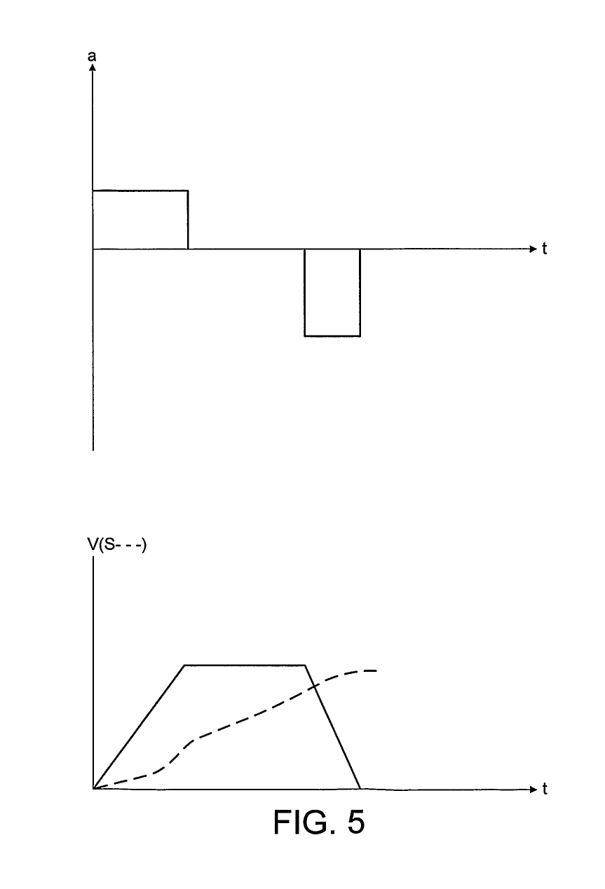

FIG. 5 shows graphs of acceleration velocity and displacement over time,

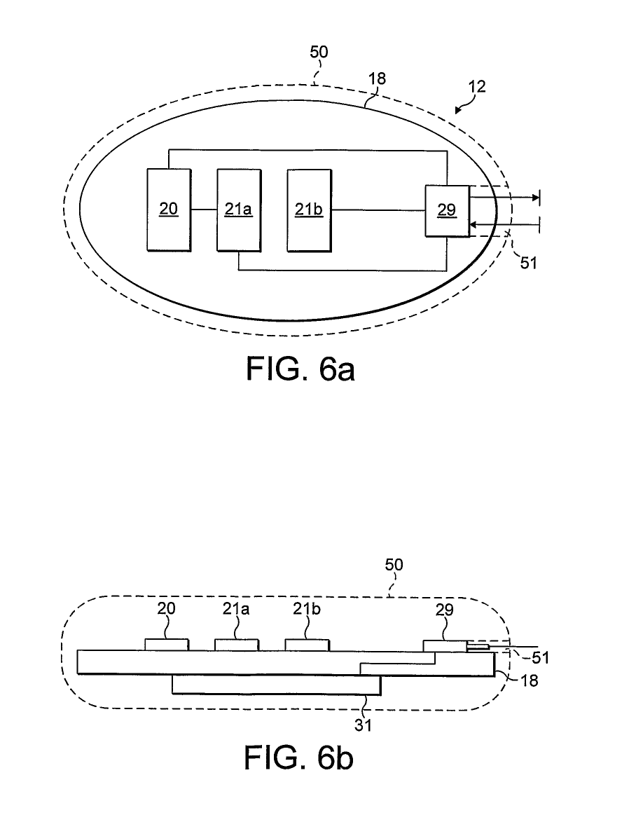

FIGS. 6a and 6b are schematic representations of a sensor node in accordance with the second aspect of the invention, and

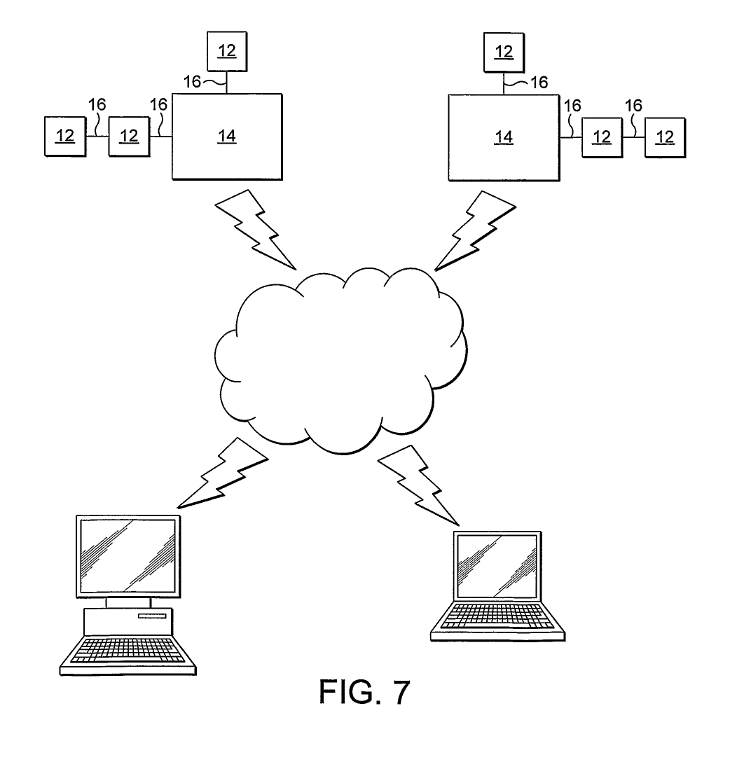

FIG. 7 is a schematic representation of multiple sensor nodes, multiple transceivers and a controller.

In FIG. 1, a motion capture apparatus 10 in accordance with the invention is shown arranged on a body A. The body A is a schematic representation of a human body. The body A has a torso B, left and right upper arms C and lower arms D. Upper legs E extend form the torso B and lower legs F extend from the upper legs E. The upper arms C are connected to the torso B at shoulder joints G. The upper arms C are articulated relative to the lower arms D by means of elbow joints H. The torso and upper legs E are articulated to each other via hip joints I and the upper legs E are articulated relative to the lower legs via knee joints J.

The motion capture apparatus 10 comprises a series of sensor nodes 12 secured to the torso B, the upper and lower arms C, D and the upper and lower legs E, F.

All of the sensor nodes 12 are connected either directly or via other sensor nodes to a transceiver module 14 by means of data cables 16. The sensor node 12 on the torso B is connected directly to the transceiver module 14. The sensor nodes 12 on the lower arms D are connected to the sensor nodes 12 on the upper arms C and then to the transceiver module 14. Likewise, the sensor nodes 12 on the lower legs F are connected to the sensor nodes 12 on the upper legs E.

One of the sensor nodes 12 and the transceiver module 14 are illustrated schematically in FIG. 2a. In FIG. 2a, the sensor node 12 comprises a double-sided printed circuit board 18 (PCB) to which are mounted, in an electrically connected manner, a three-dimensional accelerometer 20. For example, the accelerometer 20 could be a lightweight 3D accelerometer of the type made by Dytram Instruments, Inc or DJB Instruments or an Anolog Devices ADXL335 triple-axis accelerometer

The PCB 18 further includes an input port 24 for receiving the data input from another sensor 26, not mounted to the PCB 18. Furthermore, the PCB 18 includes a signal processor 28 which receives signals from the accelerometer 20 and the data input port 24 and passes those signals to a data output 30. The signal processor 28 optionally further includes data cable input 32 which can receive a data cable 16 from another node 12 and pass signals from that node to its data output 30.

The data which is passed to the data output 30 passes along a data cable 16 to the transceiver module 14. The transceiver module 14 has a series of data input ports 34 (five illustrated) which input data to a microprocessor 36. The transceiver module 14 further includes a battery power supply 38 and an antenna 40 for wirelessly transmitting data from the microprocessor 36 to a wireless receiver, for example a blue tooth receiver in a lap top computer or a wireless router in a wireless network via WiFi. The transceiver module acts as a modem between six RS405 master nodes, allowing a star-shaped configuration of sensor nodes. This reduces the amount of cable between nodes when worn on the body. Each RS485 port in the transceiver and its connected sensors may then cover each limb of the body and the head, with an extra RS485 port spare.

Nodes are hardwired in a fixed configuration at the factory. The thin and flexible cables between nodes and the transceiver are affixed using strain reliefs to prevent damage. Each configuration is dependent on the application (health care, performing arts etc) and the cables can be of any practical length. For example, in the performing acts, a small number of nodes may be distributed over the entire body, requiring long cables. Whereas in health care, it may be beneficial to have high densities of sensor nodes in certain parts of the body. In such a case, very short cables interconnecting several nodes would be required.

The number of nodes, and the way in which they are wired together is completely flexible to allow for very specific, or general configurations. Six nodes could be daisy chained together, or they could be wired to the transceiver in parallel, or a combination of both. Equally, new nodes with different sensors could be developed without any hardware changes to the transceiver, and with only minor software and firmware updates.

Due to the robust nature of RS485, nodes could be separated by up to 1200 m using shielded twisted-pair cable, such as Cat5 cable. And with a simple adapter, nodes could be wired into the existing Cat5 infrastructure that most public/commercial buildings have already. So whilst this is a wearable motion capture solution, sensor nodes can in fact be distributed over a very large area. Analysis software or the PC may include a software based low-pass filter. Alternatively each node 12 or the microprocessor 36 may have a hardware based low-pass filter.

In FIG. 4, two sensor nodes 12 are shown connected to the upper and lower arms C, D of a user. In FIG. 4a, the arm of the user is slightly bent and the angle at the inside of the elbow H is approximately 130° degrees. In FIG. 4b the user has bent the lower arm D towards the upper arm C so that the angle included by the elbow H is now approximately 50° degrees. Each of the sensor nodes 12 transmit data from the respective accelerometers to the transceiver module 14. That data is, in turn, transmitted via the microprocessor 36 to a PC (not shown). The PC applies an appropriate mathematical algorithm to the values sent from the sensor nodes and by removing the effect of the acceleration of earth gravitational pull on the accelerometers the relative orientations of the two PCBs in the centre nodes 12 can be determined. Each sensor node 12 has a unique ID which is transmitted along with the accelerometer data and thus the PC can determine the change in angle between the two sensors and model that movement. Also, the accelerometers measure the rate of acceleration in three-dimensions and, as shown in FIG. 5, the rate of acceleration can be used to determine the velocity profile and the displacement profile of the sensed movement. Thus, the speed of travel and distance of travel of each sensor node can be determined and mapped into an appropriate model.

For some applications where absolute values are not required, the data from the sensors needs to be scaled. For example, in creating a virtual drum in mid-air, how hard must a user bring his/her hand to a stand still in order for a drum sound to be triggered? This is done by scaling the sensor value to a useable range and then using a peak-trough detector to measure the force of the strike.

Converting from relative values to absolute values is fairly straightforward using well established formulas such as this for calculating pitch angle:

pitch angle relative to ground in radians=a tan 2(gx,sqrt(gy*gy+gz*gz)

where gx, gy and gz represent the acceration across the x, y and z axes.

Turning back to FIG. 1, the motion capture apparatus may further include pressure sensors 42 arranged in the shoes of a user. Those pressure sensors pass their data along data cables 16 to the data input port 24 in the central nodes 12 on the lower legs F. That arrangement allows the weight distribution of the user to be determined.

Furthermore, a flexion sensor (not shown) may be arranged on various joints, for example the elbow joint H or the knee joint J and data from the flexion sensor can again be passed via a data cable to the input port 24 on the PCB 18 of an adjacent sensor node 12.

The accelerometer outputs data at 8 bits, giving 256 possible values. In use, each sensor node is recalibrated by the user to 7 bits. Once the user has calibrated each sensor node by subjecting it to the full range of predicted movement, the range of values that represent that movement are then mapped across the 128 values that are available. This maximises the resolution available to each sensor. For example, if the full extent of movement of a particular sensor provides values in the range 50 to 200, mapping that range directly to a 7 bit range would provide a range of 25 to 100. This means that the values 0-24 and 101-127 in the 7 bit range would be unused. However, the base unit or the microprocessor 36 apply an algorithm to the measured value to map the 25-100 range across the full range of 7 bit values available.

Although we have illustrated five sensor inputs into the transceiver module 14 up to 256 sensor nodes could be connected to the transceiver module 14 either serially or in parallel.

One of the advantages of the device is its modularity. In particular, should the purpose of the motion capture exercise not require, for example, measurement of movement below the waist, the leg mounted sensor nodes 12 can be disconnected from the transceiver module 14, leaving the transceiver module 14 to process only the signals from the upper body. That is advantageous because the transceiver module will consume less power having to process and transmit fewer signals.

The transceiver works in two modules: (1) streaming and (2) call and response. In streaming mode, the transceiver collects all data from all nodes automatically and returns that data to the PC. It does not require the PC to initiate the data flow (once streaming mode has been enabled). This allows for the quickest transfer of data from sensor nodes to PC, but it is not as flexible. The data rate is dependent on the number of nodes connected. The more nodes, the slower the data rate. But if few nodes are connected, their values can be sent to the PC more quickly.

In call and response mode, the PC must ask for data from each single sensor node individually. The transceiver interprets this request, collects the data from the node and then returns the values to the computer. Whilst this might at first seem overly complicated, it allows the user to give nodes priority for data. For example, by polling certain nodes more often than others, the data rate that the PC sees for the priority nodes is quicker than that of the others. So if a node is low priority, it is polled infrequently and does not take up valuable wireless bandwidth.

The addressing structure for the nodes is hierarchical. Each node has its own ID. The transceiver then prepends the address of the RS485 port to which each node is connected. So node ID3 on RS485 port 5 is addressed as node 53. Node ID9 on port 1 would have the address 91. And so on.

So a message from the PC to request data could be:
37:5

And a response from the transceiver, once it has collected the data from the sensor node would be something like:
37:51:128:254:132:67:210:111:110

where the response is defined for that command as:
‘node’: ‘command’: ‘accelx’: ‘accely’: ‘accelz’: ‘gyrox’: ‘gyroy’: ‘gyroz’

Command may be:
1—start data streaming
11—‘start data streaming’ response
2—stop data streaming
21—‘stop data streaming’ response
3—Activate motor
31—Activate motor response
4—Calibrate
41—Calibrate response
5—get status
51—get status response

The PC software also needs to poll the transceiver for sensor values. After sending a call, it will wait for the response before sending a new call for the next set of values. At the same time (in another thread) the software deals with the data and can react in such a way that might require haptic feedback. And so haptic feedback can be initiated extremely quickly after a sensor value suggests it is needed.

A certain movement can be stored for future data analysis, or can be used as a model against which a current movement might be compared in real-time. Haptic feed then helps to guide the user's movements in a training exercise, for example.

Other, more abstract models can be implemented. For example, the software can detect if a user shakes too much, or moves too quickly in a certain way, or lacks symmetry between limbs. Haptic feedback can then be delivered during the movement in real-time to bring this deficiency to the user's attention immediately.

FIG. 2b illustrates a sensor node 12 and transceiver module 14 where the sensor node includes two two-dimensional accelerometers 20, 22.

The two-dimensional accelerometers are mounted at 90° degrees with respect to each other so that, between them, they measure accelerations in three-dimensions (as shown in FIG. 3).

The accelerometers may comprise a Dual Axis Accelerometer, for example the ADXL202E made by Analog Devices, Inc of Norwood, Mass., USA. The ADXL202E can measure dynamic acceleration and static acceleration (gravity). By orienting the accelerometers at 90° degrees with respect to each other rotations and accelerations in all three spatial dimensions can be measured.

Because the accelerometers 20, 22 are arranged to measure accelerations in all three-dimensions, a combination of the two accelerometers can determine the angular orientation of the PCB with respect to a known datum, for example the surface of the earth. Accelerometers can also measure movement and both factors are required in providing effective motion capture.

The present invention provides a hardware platform that can easily be configured to suit a number of motion capture applications such as motion training in health care or as an interactive electronic musical instrument for the performing acts, or specialist education markets. The hardware does not change, only the way in which it is wired together.

FIG. 6 a is a schematic plan view of a sensor node in accordance with the second and third aspects of the invention for use in a motion capture apparatus in accordance with the first aspect. FIG. 6b is a side elevation of the sensor node of FIG. 6a.

The node 12 comprises an elliptical, double-sided, printed circuit board 18 (“PCB”). Mounted to the upper side of the PCB are, from left to right in the figures, a three-axis accelerometer, for example an Analog Devices ADXL335, a dual axis gyroscope 21a, for example a ST Microelectronics LPR530AL, and a single axis gyroscope 21b, for example a ST Microelectronics LY530ALH and a microprocessor 29. Mounted to the underside of the PCB is a vibration transducer 31, for example a Solarbiotics VPM2 miniature vibrating pager motor. The brand names and product codes may be trade marks of Analog Devices, ST Microelectronics and Solarbiotics respectively.

The accelerometer 20, gyroscopes 21a, 21b and the transducer 31 are connected via the PCB to the microprocessor 29.

The whole PCB 18 is encapsulated in a plastics material body 50, shown in broken lines in both FIGS. 6a and b. The plastics material is selected and the body is designed to protect the node 12 from shock. It will be noted that the body around the underside of the transducer is thinner than elsewhere on the node. This is to allow vibration caused by the transducer to be transmitted effectively to the wearer, when worn transducer side down on the body. The body material and shape is preferably designed so that vibration induced by the transducer is immediately attenuated by the body when the transducer is deactivated. That aids in the use of the above described quasi-simultaneous sensing and vibration, as the quicker the vibrations are damped out after power to the transducer has been cut, the quicker sensing of movement via the accelerometer can recommence. The body 50 has a port 51 to allow passage of data cable to the PCB or microprocessor. The body 50 may also include a fitting for a strap (not shown) to allow a strap to be secured to the node 12 to enable it to be secured to the wearer. It is also envisaged that the apparatus could be incorporated into a garment.

FIG. 7 is a schematic view of a motion capture apparatus in accordance with the invention. As mentioned above, the nodes 12 and transceiver module 14 form an RS485 network. As illustrated in FIG. 7, multiple sets of nodes 12 and modules 14 can communicate wirelessly with a wireless router, enabling the modules to send data to and be controlled by computers in a local or wide area network. For example, where the apparatus is in a garment, multiple such garments could be worn by people carrying out manual handling training at multiple remote sites simultaneously. A central control could review and identify those people that were not complying with correct manual handling procedure allowing restorative action.

1. A motion capture apparatus comprising a first 3-dimensional accelerometer, which can output a signal relative to its angular orientation, a second 3-dimensional accelerometer which can output a signal relative to its angular orientation, a processor for processing the angular orientation signals of the accelerometers and for determining the relative angle between the first and second accelerometers.

2. A motion capture apparatus according to claim 1 in which more than two 3-dimensional accelerometers are provided.

3-46. (canceled)
